(19) United States
(12) Patent Application Publication
(10) Pub. No.: US 2015/0244906 A1
(43) Pub. Date: Aug. 27, 2015

(54) REFLECTING MIRROR STRUCTURE FOR CAMERA MODULE

(71) Applicant: TDK TAIWAN CORP., Taoyuan County (TW)

(72) Inventors: Fu-Yuan WU, Taoyuan County (TW); Yu-Sheng LI, Taoyuan County (TW)

(21) Appl. No.: 14/597,396

(22) Filed: Jan. 15, 2015

(30) Foreign Application Priority Data
Feb. 27, 2014 (TW) 103106681

(51) Int. Cl. H04N 5/225; H04N 5/232; G03B 17/12

(52) U.S. Cl. CPC H04N 5/2254; G03B 17/12; H04N 5/23296; H04N 5/23238

(57) ABSTRACT

Provided is a reflecting mirror structure which includes: a camera module; a reflecting mirror rotation axis parallel to an optical axis of the camera module; and a reflecting mirror connected to an end of the reflecting mirror rotation axis to form an included angle with the optical axis, wherein the reflecting mirror rotates about the reflecting mirror rotation axis in accordance with a position of a target object to project an image of the target object into the camera module.

### BACKGROUND OF THE INVENTION

1. Field of the Invention

The present invention relates to reflecting mirror structures, and more particularly, to a reflecting mirror structure for use with a camera module.

2. Description of the Prior Art

Camera modules are in increasingly wide use in recent years, and they are becoming more applicable to mobile devices. Hence, it is no longer feasible to equip a mobile device with just one camera module in order to take pictures; instead, it is quite common nowadays for a mobile device to be equipped with at least two camera modules for meeting diverse consumer needs, such as taking selfies.

A mobile device equipped with two camera modules is effective in rendering a picture-taking direction precise and taking selfies. Nonetheless, it is even more advantageous to take pictures and selfies with a mobile device equipped with just one camera module. To this end, the prior art is characterized in that: an image is reflected and projected into a camera module with a reflecting mirror whose reverse axis is perpendicular to an optical axis in a usual shooting mode; in a selfie-taking mode, the reflecting mirror turns over about the reverse axis perpendicular to the optical axis and thus causes the image to travel in another direction in order to enter the camera module; hence, by turning the reflecting mirror over, the reflecting mirror reflects and projects images into the camera module traveling in two directions, i.e., forward and backward, respectively. But the prior art is restricted to the forward direction and the backward direction. As a result, more camera modules are required to take pictures of an image traveling in a direction other than a forward direction and a backward direction.

To take panoramas, a handheld picture-taking device user rotates the picture-taking device horizontally while shooting the scene. However, the manual rotation of the picture-taking device does not ensure that the picture-taking device can shoot the scene in a precisely horizontal direction, and in consequence the panoramas are seldom perfect.

Accordingly, it is imperative to provide a reflecting mirror for use with a camera module in taking pictures of images traveling in multiple directions or even in all directions.

### SUMMARY OF THE INVENTION

In view of the aforesaid drawbacks of the prior art, it is an objective of the present invention to provide a reflecting mirror structure for use with a camera module in taking pictures of images traveling in multiple directions.

In order to achieve the above and other objectives, the present invention provides a reflecting mirror structure which comprises a camera module, a reflecting mirror rotation axis parallel to an optical axis of the camera module, and a reflecting mirror connected to an end of the reflecting mirror rotation axis, such that an included angle is formed between the reflecting mirror and the optical axis, wherein the reflecting mirror rotates about the reflecting mirror rotation axis in accordance with the position of a target object to project the image of the target object into the camera module.

Accordingly, a camera module with a reflecting mirror structure of the present invention not only takes pictures of images traveling in two directions perpendicular to an optical axis, namely, a forward direction and a backward direction, but also takes pictures of images traveling in any other direction perpendicular to the optical axis. Hence, a camera module with the reflecting mirror structure of the present invention takes pictures of images traveling in at least three directions, thereby dispensing with the need to provide multiple camera modules or any intricate devices.

The aforesaid and other aspects of the present invention are illustrated with non-restrictive specific embodiments below and the accompanying drawings.

### BRIEF DESCRIPTION OF THE DRAWINGS

FIG. 1 is a schematic view of a reflecting mirror structure of the present invention;

FIG. 2 is a schematic view of another reflecting mirror structure shot at a different angle according to the present invention;

FIG. 3 is a schematic view of yet another reflecting mirror structure shot at a different angle according to the present invention;

FIG. 4 is a schematic view of reflecting mirror structure modularization according to the present invention; and

FIG. 5 is a schematic view of the present invention applicable to a mobile device.

### DETAILED DESCRIPTION OF THE EMBODIMENTS

To facilitate the comprehension of the technical features, contents, advantages, and achievable effects of the present invention, the present invention is illustrated with drawings and embodiments and described below. The drawings, which serve exemplary and supplementary purposes, are not necessarily drawn to scale; hence, the drawings are illustrative rather than restrictive of the claims of the present invention.

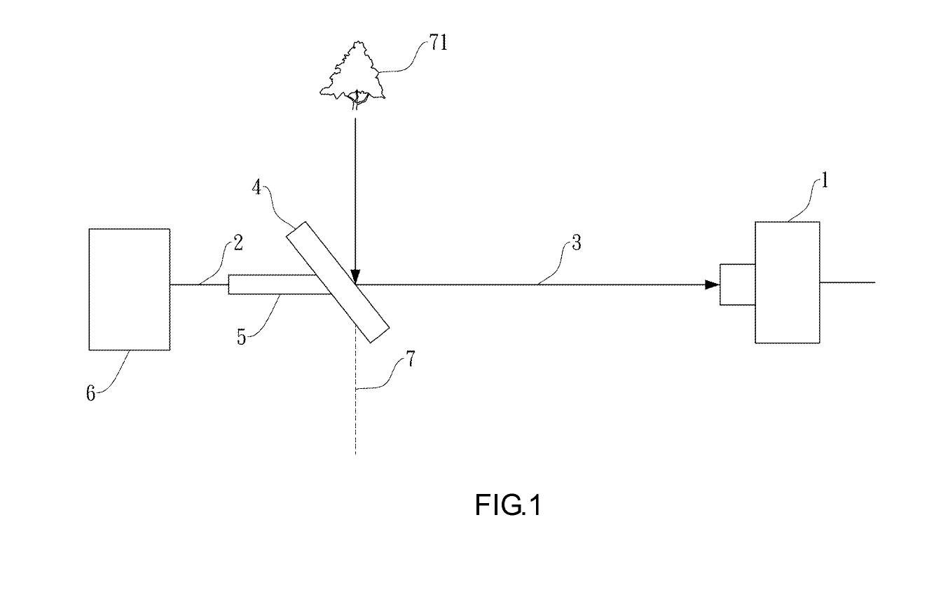

Referring to FIG. 1, there is shown a schematic view of a reflecting mirror structure according to an embodiment of the present invention. As shown in the diagram, the reflecting mirror structure comprises: a camera module 1; a reflecting mirror rotation axis 2 disposed at an optical axis 3 of the camera module 1; a reflecting mirror 4 disposed at the optical axis 3 and facing the camera module 1, wherein an included angle of 45 degrees is formed between the reflecting mirror 4 and the optical axis 3; a reflecting mirror support 5 disposed at the reflecting mirror rotation axis 2 and connected to the reflecting mirror 4; and a rotary mechanism 6 for rotating the reflecting mirror support 5 about the optical axis 3 to drive the reflecting mirror 4 to rotate about the reflecting mirror rotation axis 2. As shown in FIG. 1, when viewed in a direction, a target object 71 is disposed on a plane 7 passing through the optical axis 3 and being perpendicular to the optical axis 3. The reflecting mirror 4 reflects and projects the image of the target object 71 into the camera module 1.

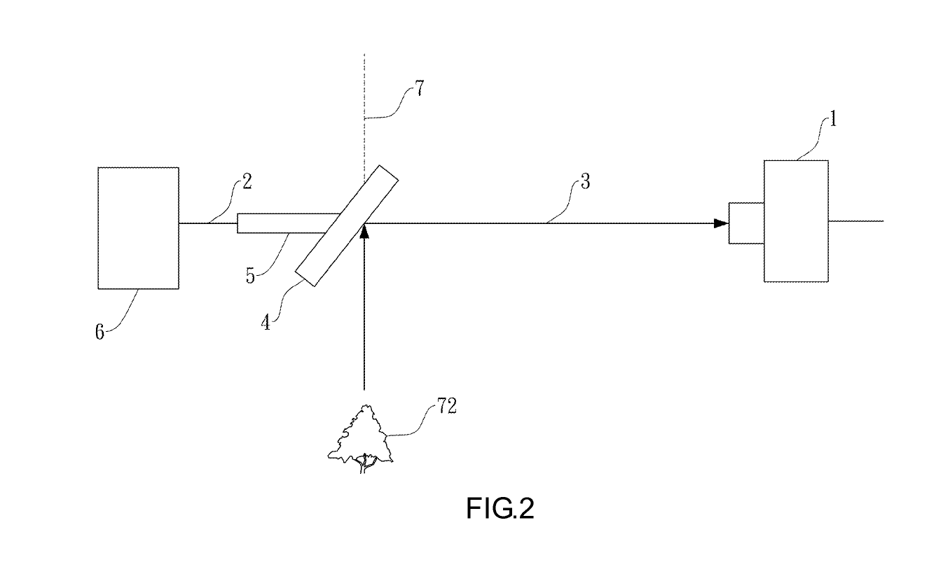

In the embodiment, when viewed in another direction, a target object 72 is disposed on the plane 7 passing through the optical axis 3 and being perpendicular to the optical axis 3. The rotary mechanism 6 rotates the reflecting mirror support 5 about the reflecting mirror rotation axis 2 to drive the reflecting mirror 4 to rotate about the reflecting mirror rotation axis 2 by 180 degrees; meanwhile, the position of the reflecting mirror 4 is shown in FIG. 2, and the reflecting mirror 4 reflects and projects the image of the target object 72 into the camera module 1. Likewise, in the embodiment, when viewed in any direction, a target object is disposed on the plane 7 passing through the optical axis 3 and being perpendicular to the optical axis 3. The rotary mechanism 6 rotates appropriately in accordance with the position of the target object to cause the reflecting mirror 4 to reflect and project the image of any target object disposed on the plane 7 and viewed in any direction into the camera module 1, so as to provide a camera module capable of taking pictures in any directions. In another embodiment, the rotary mechanism 6 is a hand-operated device for rotating the reflecting mirror support 5 manually and thus rotating the reflecting mirror 4. In this embodiment, the rotation of the reflecting mirror 4 is effectuated in a simple manner. In another embodiment, the rotary mechanism 6 is a motor controlled by an electronic signal or by any other means to rotate the reflecting mirror support 5 and thus rotate the reflecting mirror 4.

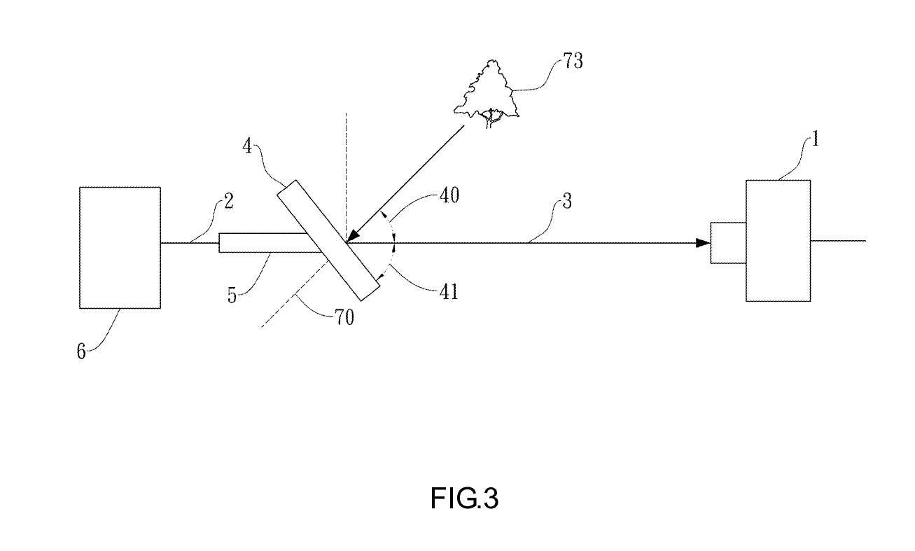

Depending on user needs, the target objects in the aforesaid embodiments are subject to changes. When the target object is disposed on the plane 7 passing through the optical axis 3 and being perpendicular to the optical axis 3, it is feasible to adjust the included angle between the reflecting mirror 4 and the optical axis 3 such that the image of the target object is projected into the camera module 1 to effectuate a picture-taking function. For instance, in an embodiment, a target object 73 is disposed on a plane 70 passing through the optical axis 3 in a manner to form a first included angle of 45 degrees between the plane 70 and the optical axis 3. Referring to FIG. 3, a second included angle 41 is formed between the reflecting mirror 4 and the optical axis 3 and calculated to be 67.5 degrees. In the embodiment, the second included angle 41 between the reflecting mirror 4 and the reflecting mirror support 5 is designed to equal 67.5 degrees, so as to capture images from the plane 70 which forms an included angle of 45 degrees with the optical axis 3. In some circumstances, the reflecting mirror rotation axis 2 is not necessarily disposed at the optical axis 3 but can be parallel to the optical axis 3.

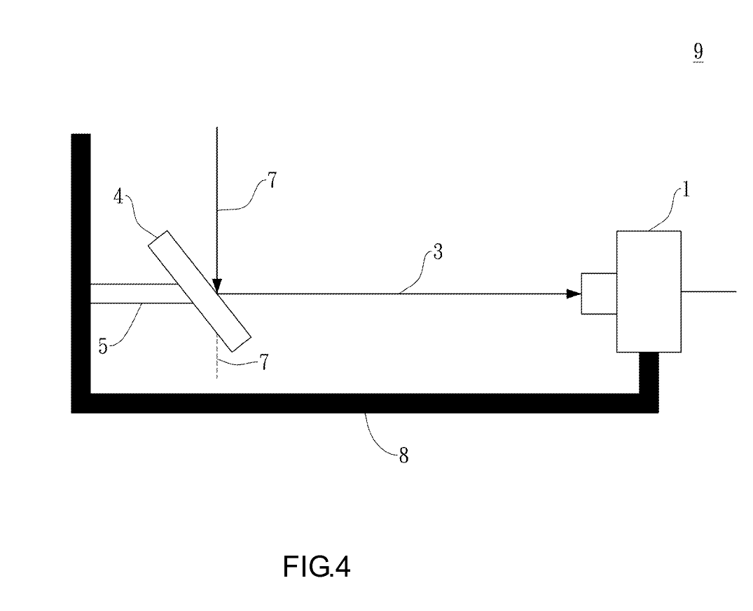

To facilitate modularization, in an embodiment, it is practicable to combine the camera module 1, the reflecting mirror 4, the reflecting mirror support 5, and a module brace 8. Referring to FIG. 4, reference is made to the preceding embodiment, but the combination is modularized with the module brace 8 to achieve a design in which a camera module 9 has a reflecting mirror, such that the camera module 9 can be shared by different systems. Hence, in the embodiment, given an applicable mechanism, the camera module 9 can be shared by different systems or any other applications which require a picture-taking function, so as to save time for an additional design process.

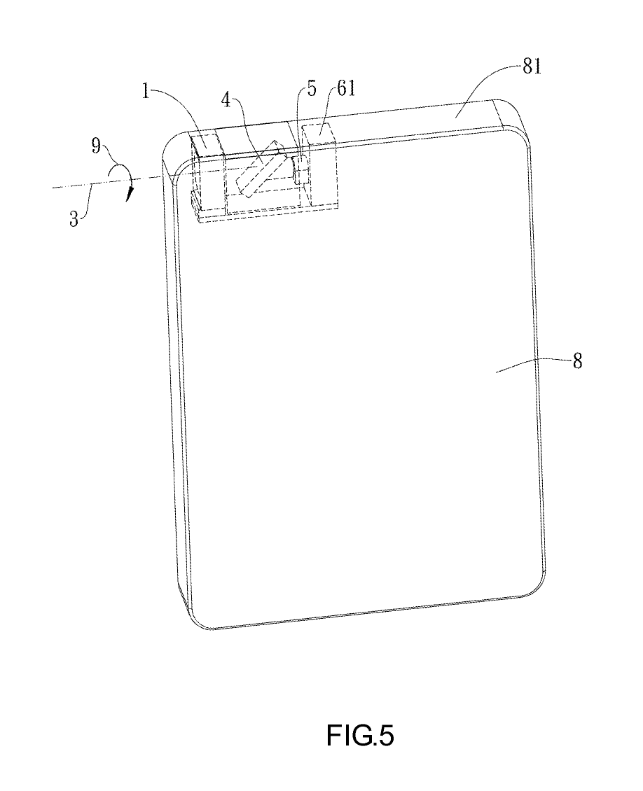

The technical features of the present invention are applied to devices, including but not limited to mobile devices, in taking panoramas or wide-angle pictures. In an embodiment, referring to FIG. 5, a device comprises a device casing 8, the reflecting mirror 4, the reflecting mirror support 5, the camera module 1, and a rotary motor 61, wherein the reflecting mirror 4 is rotated in the same manner as described in the aforesaid embodiment. In this embodiment, the optical axis 3 is parallel to a device side 81, and the rotary motor 61 rotates the reflecting mirror support 5 to drive the reflecting mirror 4 to rotate relative to the camera module 1, such that the reflecting mirror 4 rotates by 180 degrees in a rotation direction 9 or in a direction opposite thereto so as to automatically take pictures at a wide angle of 180 degrees, thereby dispensing with the need to move the device while taking the wide-angle pictures. In the embodiment, given an appropriate mechanism, the rotation direction 9 is not limited to rotating by 180 degrees but includes rotating by less than 180 degrees and more than 180 degrees. In the embodiment, the rotation angle of the rotary motor 61 is adjusted as needed, so as to take pictures, such as panoramas and wide-angle pictures, at appropriate angles which are less than, equal to, or larger than 180 degrees.

In conclusion, the present invention provides a reflecting mirror structure whereby images traveling in non-specific directions are reflected and projected into a single camera module in a manner to enable the single camera module to function as a plurality of camera modules.

A reflecting mirror structure according to preferred embodiments of the present invention is described above and illustrated with drawings. All the technical features disclosed herein can integrate with the other methods. Each of the technical features disclosed herein can be selectively replaced with an identical, equivalent, or similar target feature; hence, barring conspicuous features, all the technical features disclosed herein merely serve to exemplify equivalent or similar features. After studying the preferred embodiments of the present invention, persons skilled in the art understand that the present invention relates to an invention which has novelty, non-obviousness, and high industrial applicability and thus is worthy of development. The present invention can be modified in various ways by persons skilled in the art and still fall within the appended claims.

What is claimed is:

1. A reflecting mirror structure, comprising:
a camera module;
a reflecting mirror rotation axis parallel to an optical axis of the camera module; and
a reflecting mirror connected to an end of the reflecting mirror rotation axis to form an included angle with the optical axis,
wherein the reflecting mirror rotates about the reflecting mirror rotation axis in accordance with a position of a target object to project an image of the target object into the camera module.

2. The reflecting mirror structure of claim 1, further comprising a reflecting mirror support connected to the reflecting mirror and parallel to the optical axis.

3. The reflecting mirror structure of claim 2, wherein the reflecting mirror support rotates to drive the reflecting mirror to rotate.

4. The reflecting mirror structure of claim 1, wherein an included angle between the reflecting mirror and the optical axis equals 45 degrees.

5. The reflecting mirror structure of claim 1, further comprising a rotary mechanism for rotating the reflecting mirror.

6. The reflecting mirror structure of claim 5, wherein the rotary mechanism is one of a hand-operated actuator and a motor-driven actuator.

7. The reflecting mirror structure of claim 5, wherein the reflecting mirror rotates while taking pictures.

8. The reflecting mirror structure of claim 1, wherein the camera module operates in conjunction with the reflecting mirror in taking pictures of the target object on a plane perpendicular to the optical axis.

9. A picture-taking device, comprising the reflecting mirror structure of claim 1, the picture-taking device further comprising:
a rotary mechanism for rotating the reflecting mirror; and
a device casing for holding the camera module, the reflecting mirror rotation axis, the reflecting mirror, and the rotary mechanism,
wherein the rotary mechanism rotates the reflecting mirror so as to take pictures.

10. The picture-taking device of claim 9, wherein the rotary mechanism is one of a hand-operated actuator and a motor-driven actuator.

11. A reflecting mirror structure, comprising:
a camera module;
a reflecting mirror rotation axis parallel to an optical axis of the camera module; and
a reflecting mirror connected to an end of the reflecting mirror rotation axis to form an included angle with the optical axis,
wherein the reflecting mirror rotates about the reflecting mirror rotation axis in accordance with a position of a target object to project an image of the target object into the camera module.
